(19) United States
(12) Patent Application Publication
(10) Pub. No.: US 2017/0161777 A1
(43) Pub. Date: Jun. 8, 2017

(54) METHOD AND SYSTEM FOR VALUATION OF SOCIAL INFLUENCE

(71) Applicant: MasterCard International Incorporated, Purchase, NY (US)

(72) Inventors: Randall K. SHUKEN, Westport, CT (US); Debashis GHOSH, Charlotte, NC (US); Manash BHATTACHARJEE, Jersey City, NJ (US)

(73) Assignee: MasterCard International Incorporated, Purchase, NY (US)

(21) Appl. No.: 14/960,842

(22) Filed: Dec. 7, 2015

(51) Int. Cl. G06Q 30/02; G06Q 50/00; G06F 17/30

(52) U.S. Cl. CPC G06Q 30/0246; G06F 17/30321; G06Q 30/0201; G06Q 50/01

(57) ABSTRACT

A method for generation of an index of influence for an individual using social network and electronic transaction data includes: storing transaction messages, each related to a transaction including a time, date, and transaction data; receiving social media data associated with a user of a social network, the data including a number of followers and secondary followers of the user and data associated with shared content including a shared time, shared date, and a data value corresponding to a product or merchant; identifying transaction messages where the time and date are within a predetermined period of the shared time and date and where the transaction data corresponds to the data value; calculating a rate of return for the user based on the number of followers and secondary followers and the number of transaction messages in the subset; and identifying an influence index based on the calculated rate of return.

### FIELD

The present disclosure relates to the valuation of social influence of an individual in a social network, specifically the generating of an index representative of an individual's social influence based on actions of followers in the individual's social networks.

### BACKGROUND

Merchants, retailers, advertisers, and other content providers are always looking for new ways to not only identify useful content, but to also identify new and improved ways to target recipients for the content and to distribute the content to the recipients. As social networks become more and more prevalent in the daily life of countless consumers, content providers have begun to use social networks as a way to reach target audiences. In many cases, a content provider will identify a celebrity or other personality that has a following on the social network that is of an adequate size and of a suitable demographic, and encourage the personality to share content so that it can be seen by their followers on that social network. The sharing of content by a single person can thus reach thousands and potentially millions of other individuals, and in a way that is endorsed by someone the individuals willingly follow.

However, it can be exceedingly difficult for a content provider to not only identify a suitable individual for sharing of their content, but to also identify the results of such sharing. For instance, a product manufacturer may have an individual share content about a product, but may be unable to identify or quantify the effect of that sharing on consumers' behavior.

Thus, there is a need for a technical solution whereby the influence of an individual in a social network can be valuated or quantified based on not only their followers, but also the followers of their followers, in an automated computer implemented manner so that it is reasonably accurate for a given purpose, scalable and not require or necessarily involve human interaction.

### SUMMARY

The present disclosure provides a description of systems and methods for generating an index of influence for an individual using social network and electronic transaction data that is captured during the transactional process such that it can be more easily and efficiently captured, aggregated, and evaluated in an automated, computer implemented manner.

A method for generation of an index of influence for an individual using social network and electronic transaction data includes: storing, in a transaction database of a processing server, a plurality of transaction messages, wherein each transaction message is formatted based on one or more standards and includes data related to a payment transaction including at least a plurality of data elements including a first data element configured to store a time, a second data element configured to store a date, and one or more additional data elements configured to store transaction data; receiving, by a receiving device of the processing server, a data message electronically transmitted via a communication network, wherein the data message is superimposed with social media data associated with a user of a social network, the social media data including at least (i) a number of followers of the user on the social network, (ii) a number of followers of the followers of the user on the social network, and (iii) sharing data associated with content shared by the user on the social network that includes at least a shared time, shared date, and a data value corresponding to a product or merchant; executing, by a querying module of the processing server, a query on the transaction database to identify a subset of transaction messages where the time stored in the first data element in the respective transaction message is within a predetermined period of time of the shared time included in the sharing data, the date stored in the second data element in the respective transaction message is within a predetermined range of the shared date included in the sharing data, and a data value stored in one of the one or more additional data elements corresponds to the date value corresponding to the product or merchant included in the sharing data; calculating, by a calculation module of the processing server, a rate of return for the user on the social network based on at least the number of followers of the user on the social network, the number of followers of the followers of the user on the social network, and a number of transaction messages included in the identified subset of transaction messages; and identifying, by an indexing module of the processing server, an influence index for the user based on at least the calculated rate of return.

A system for generation of an index of influence for an individual using social network and electronic transaction data includes a transaction database, a receiving device, a querying module, a calculation module, and an indexing module of a processing server. The transaction database of the processing server is configured to store a plurality of transaction messages, wherein each transaction message is formatted based on one or more standards and includes data related to a payment transaction including at least a plurality of data elements including a first data element configured to store a time, a second data element configured to store a date, and one or more additional data elements configured to store transaction data. The receiving device of the processing server is configured to receive a data message electronically transmitted via a communication network, wherein the data message is superimposed with social media data associated with a user of a social network, the social media data including at least (i) a number of followers of the user on the social network, (ii) a number of followers of the followers of the user on the social network, and (iii) sharing data associated with content shared by the user on the social network that includes at least a shared time, shared date, and a data value corresponding to a product or merchant. The querying module of the processing server is configured to execute a query on the transaction database to identify a subset of transaction messages where the time stored in the first data element in the respective transaction message is within a predetermined period of time of the shared time included in the sharing data, the date stored in the second data element in the respective transaction message is within a predetermined range of the shared date included in the sharing data, and a data value stored in one of the one or more additional data elements corresponds to the date value corresponding to the product or merchant included in the sharing data. The calculation module of the processing server is configured to calculate a rate of return for the user on the social network based on at least the number of followers of the user on the social network, the number of followers of the followers of the user on the social network, and a number of transaction messages included in the identified subset of transaction messages. The indexing module of the processing server is configured to identify an influence index for the user based on at least the calculated rate of return.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high-level system architecture for valuating social influence of an individual using social network and transaction data in accordance with exemplary embodiments.

FIG. 2 is a block diagram illustrating the processing server of FIG. 1 for generating an index of influence using social network and transaction data in accordance with exemplary embodiments.

FIG. 3 is a flow diagram illustrating a process for distributing content based on individual social network influence valuated using social network and transaction data using the system of FIG. 1 in accordance with exemplary embodiments.

FIG. 4 is a flow chart illustrating an exemplary method for generating an index of influence for an individual using social network and electronic transaction data in accordance with exemplary embodiments.

FIG. 5 is a flow diagram illustrating the processing of a payment transaction in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require and special knowledge in offered products. In some embodiments, an entity involved in a single transaction may be considered a merchant. In some instances, as used herein, the term “merchant” may refer to an apparatus or device of a merchant entity.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

### System for Valuating Social Network Influence

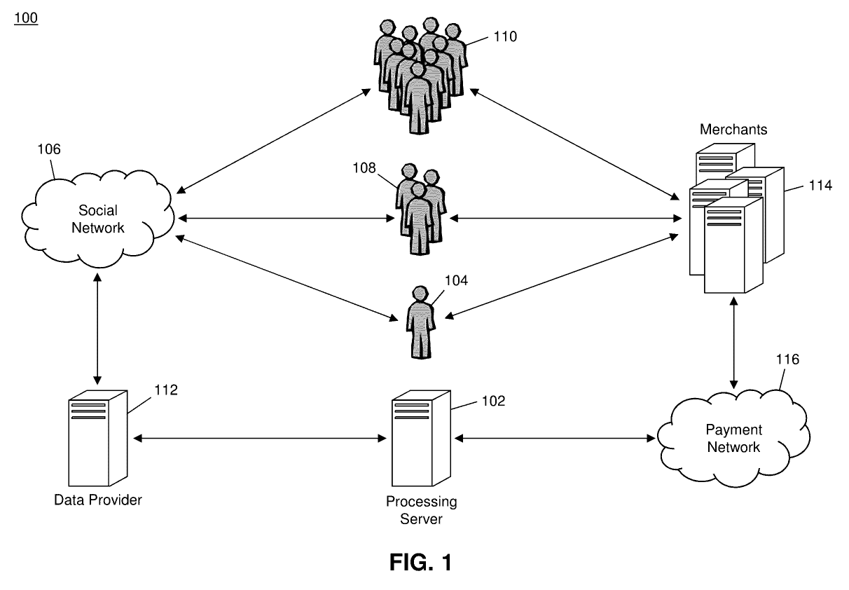

FIG. 1 illustrates a system 100 for the valuation of influence of an individual based on social network data and electronic transaction data.

The system 100 may include a processing server 102. The processing server 102, discussed in more detail below, may be configured to generate an index representative of the influence of an individual 104 over others with respect to a product or merchant, based on social network data for the individual 104 and electronic transaction data associated with the product or merchant.

The individual 104 may be a part of one or more social networks 106. A social network 106 may be a network of social interactions and relationships that is used by the individual 104 to manage the relationships and interactions and share content with their followers 108 in the social network 106, such as by sharing images, audio, video, text, etc. As used herein, “social network” may refer to an entity that operates a social network, as well as the hardware and/or software used in the management and operation of the social network, such as the websites and application programs used by the individual 104 and their followers 108 in accessing the social network. Social networks 106 may include, for example, Facebook, Twitter, FourSquare, Snapchat, Google+, YouTube, etc.

Followers 108 may be other users of the social network 106 that “follow” the individual 104, and are therefore recipients of content shared by the individual 104. When content, such as a message, image, or video, is shared by the individual 104, each of the followers 108 may receive or otherwise be able to view the shared content. Each of the followers 108 may also have followers of their own that view content shared by themselves, which may include individually produced content, or may be a re-sharing of the content shared by the individual 104. The aggregate pool of users that comprise followers of the followers 108 may be referred to herein as secondary followers 110. In some instances, the secondary followers 110 may not include any followers 108. In other instances, a user may be both a follower 108 and a secondary follower 110, such as if they follow the individual 104 and another follower 108, as they may thus receive content shared by the individual 104 twice due to re-sharing by the other follower 108 that they follow.

The system 100 may include a data provider 112. The data provider 112 may be configured to collect social network data from the social network 106. The social network data may include data related to content shared by users of the social network 106, as well as information associated with individual users and their followers, such as the individual 104, the followers 108, and the secondary followers 110. In an exemplary embodiment, the social network data collected by the data provider 112 may be data that the individual 104 has given permission for the collection thereof (e.g., by “opting-in” to the collection of the social network data). In some instances, the data collected regarding the individual's followers 108 and/or secondary followers 110 may only be collected for those followers 108 and secondary followers 110 that have also opted-in for data collection. The data provider 112 may be configured to electronically transmit data signals to the processing server 102 that are superimposed with the social network data using a suitable communication network, such as the Internet, a local area network, a wireless area network, a radio frequency network, etc. In some instances, the data provider 112 may electronically transmit data signals associated with each user of the social network 106. In other instances, the data provider 112 may aggregate user social network data in data signals that are electronically transmitted to the processing server 102, such as to reduce the number of transmissions.

In some embodiments, the processing server 102 may electronically transmit a data signal to the data provider 112 using a suitable communication network that is superimposed with a social network data request. The social network data request may identify the individual 104 for which social network data is requested, such as by including an identifier associated with the individual 104. In some instances, the social network data request may also specify one or more criteria for use in the identification of social network data, such as by specifying a date range for shared content, a filter for the identification of content shared by the individual 104, etc. For example, if the processing server 102 is identifying the influence of the individual 104 with respect to a specific product, the social network data request may identify the specific product such that the data provider 112 may identify instances where content shared by the individual 104 is associated with that product, such as by using a product identifier, such as a universal product code, stock keeping unit, manufacturer's part number, product name, product image, etc.

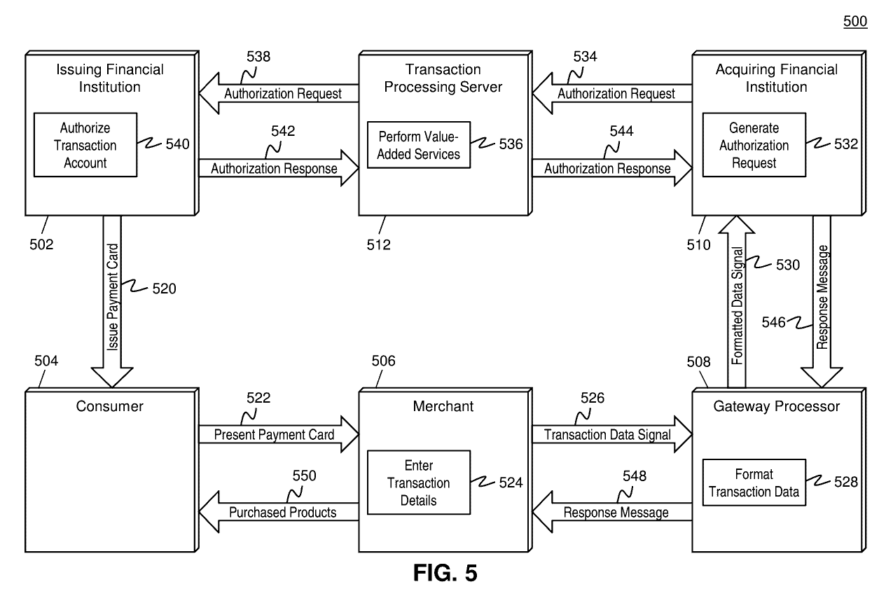

The processing server 102 may use the social network data to valuate the influence of the individual 104 on the social network 106 in conjunction with transaction data. Transaction data may be captured for payment transactions involving the individual 104, the followers 108, and the secondary followers 110. Each of the users of the social network 106 may conduct payment transactions with a plurality of merchants 114 using traditional systems and methods. Some or all of the payment transactions may be processed by a payment network 116 using traditional systems and methods, such as discussed in more detail below with respect to the process 500 illustrated in FIG. 5. The payment network 116 may receive transaction messages for payment transactions involving the merchants 114 and users of the social network 106. Transaction messages may be data messages specially formatted pursuant to one or more standards governing the exchange of financial transaction messages, such as the International Organization for Standardization's ISO 8583 standard. Each transaction message may include a plurality of data elements configured to store data as set forth by the associated standard(s), such as data elements configured to store a primary account number associated with a transaction account used to fund the payment transaction, an identifier associated with the merchant 114 involved in the transaction, a transaction amount, a geographic location, a transaction time, a transaction date, product data, merchant data, consumer data, offer data, reward data, loyalty data, point of sale data, etc.

The payment network 116 may electronically transmit transaction messages for payment transactions to the processing server 102. In some instances, the transaction messages may be transmitted via data signals transmitted using the payment rails, which may be specialized infrastructure associated with the payment network 116, as discussed in more detail below. In other instances, the transaction messages may be transmitted using an alternative, suitable communication network. In some embodiments, the processing server 102 may electronically transmit a data signal superimposed with a transaction request to the payment network 116, which may request transaction messages for payment transactions. In some cases, the transaction request may include information associated with a valuation being performed by the processing server 102, such as requesting transaction messages related to transactions for the purchase of the product or merchant associated with the content shared by the individual 104, requesting transaction messages for transactions in a specific time and/or date range, requesting transaction messages in a specific geographic area, etc.

In some embodiments, the processing server 102 may be a part of the payment network 116. In such embodiments, the processing server 102 and/or payment network 116 may store transaction messages for payment transactions processed by the payment network 116 for use in performing the functions discussed herein. In such instances, the processing server 102 may receive transaction messages via internal communication networks of the payment network 116 or may access transaction messages stored in a database associated with the payment network 116 that may be stored locally in the payment network 116 or externally and accessed via a suitable communication method, such as via cloud computing techniques.

The processing server 102 may be configured to valuate the influence of the individual 104 based on the received social network data and transaction data. The valuation may be based on a rate of return for the individual 104 that is based on at least the number of followers 108 and secondary followers 110 for the individual 104 as well as a number of transaction messages related to payment transactions involving the product or merchant associated with content shared by the individual 104 that are conducted within a predetermined period of time following the sharing of the content by the individual 104. The predetermined period of time may be set by the processing server 102 or another entity, such as an entity requesting the valuation of the influence of the individual 104, and may be based on any criteria associated with the valuation, such as the type of product or merchant, the rate at which the individual 104 shares content, the social network 106 for which the individual 104 is being valuated, the length of time between the individual 104 sharing the content and another user sharing similar or related content, etc. For instance, the predetermined period of time may be greater for a social network 106 where individuals post content less often, and may also be limited by the sharing of content for the same product or merchant by another user, such as one with a following above a predetermined number such that it may affect the transaction data.

The processing server 102 may identify an index for the individual 104 based on the calculated rate of return. The index may be based on the rate of return for the individual 104 as compared to other users of the same social network 106, for the same individual 104 or other users on other social networks 106, for the same individual 104 and other products or merchants, and other measures that may be used for comparison to the rate of return for the individual 104, the social network 106, and the product or merchant for use in identifying an index associated therewith. In some instances, the index may be weighted, such as based on the product or merchant, the social network 106, etc. For example, a particular social network 106 may have a higher likelihood for users to be influenced by shared content due to various aspects of the social network 106, such as exclusivity of the network, rate of sharing, quality of content, etc. In another example, the rate of return may be weighted for a more expensive product than a less expensive product due to the greater revenue received from purchases of the more expensive product. In some instances, the index for an individual 104 may be based on a rate of return for the individual across multiple social networks 106.

The processing server 102 may be configured to provide the index for the individual 104 to an entity, such as to an advertiser or other content provider that may want to have the individual 104 share content on their behalf. For example, a content provider may electronically transmit a data signal to the processing server 102 using a suitable communication network that includes an index request that specifies an individual 104 and a social network 106. The processing server 102 may identify the index of influence for that individual 104 on the social network 106 and may electronically transmit a data signal back to the content provider that is superimposed with the index of influence. In some instances, the index request may specify a product. In other instances, the processing server 102 may identify one or more products for which an index is identified based on the content shared by the individual 104. In some cases, the processing server 102 may identify, and return to the content provider, a separate index of influence for each of the shared products or merchants or for groups of related products or merchants. For instance, the processing server 102 may identify an index of influence for electronics, one for clothing, and one or more restaurants.

The methods and systems discussed herein enable the processing server 102 to efficiently and accurately identify an index of influence for an individual 104 based on social network and electronic transaction data. By using secondary followers 110 for an individual 104 in addition to followers 108, the scope of influence for an individual 104 may be more accurately identified, particularly for an individual 104 that may not have a lot of followers 108, but whose followers 108 may themselves be influential to the secondary followers 110. In addition, by collecting transaction data from transaction messages at a payment network 116, the processing server 102 may capture transaction data at a centralized point in the transaction process without the need to aggregate data from multiple merchants and locations and thus may also capture transaction data without modification to existing merchant transaction systems, by virtue of the technical configuration of the processing server 102.

### Processing Server

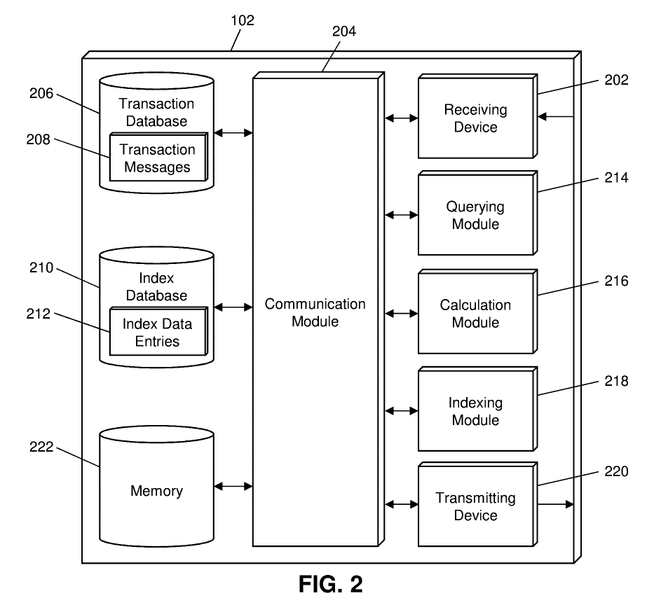

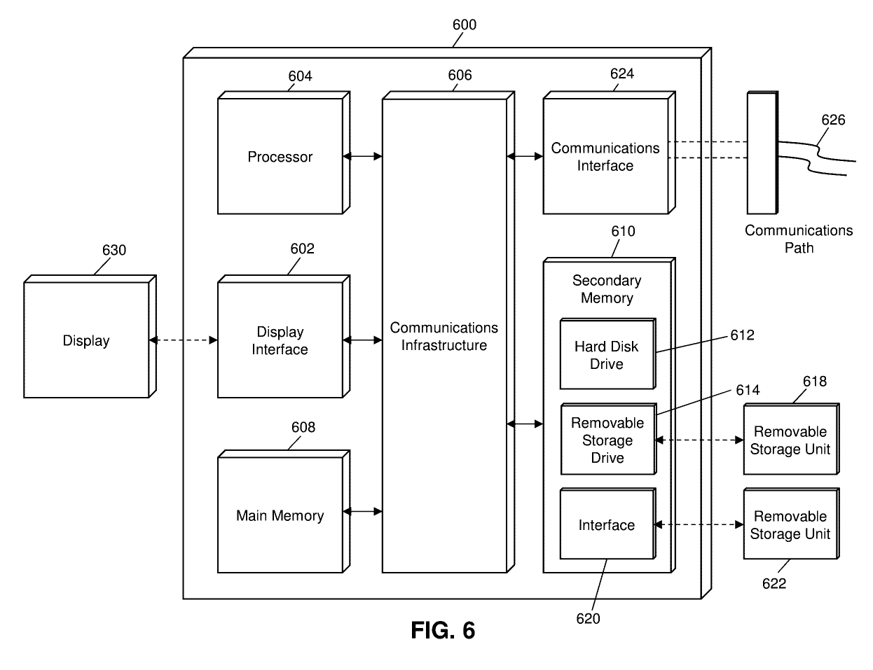

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 600 illustrated in FIG. 6 and discussed in more detail below may be a suitable configuration of the processing server 102.

The processing server 102 may include a receiving device 202. The receiving device 202 may be configured to receive data over one or more networks via one or more network protocols. In some embodiments, the receiving device 202 may be configured to receive data over the payment rails, such as using specially configured infrastructure associated with payment networks 116 for the transmission of transaction messages that include sensitive financial data and information. In some instances, the receiving device 202 may also be configured to receive data from data providers 112, social networks 106, merchants 114, payment networks 116, and other entities via alternative networks, such as the Internet. In some embodiments, the receiving device 202 may be comprised of multiple devices, such as different receiving devices for receiving data over different networks, such as a first receiving device for receiving data over payment rails and a second receiving device for receiving data over the Internet. The receiving device 202 may receive electronically data signals that are transmitted, where data may be superimposed on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals from the data provider 112 and/or social network 106 using a suitable communication network that are superimposed with social network data. The social network data may include at least a number of followers 108 for an individual 104, a number of secondary followers 110 for the individual 104, and sharing data. The sharing data may be associated with content shared by the individual 104 on the social network 106 and include at least a time and date at which the content was shared, as well as a data value associated with a product or merchant that is associated with the shared content. In exemplary embodiments, the social network data and/or the sharing data may be received only if expressly consented to by the associated individual 104. The data value may be, for example, a product identifier (e.g., universal product code, stock keeping unit, manufacturer's part number, registration number, serial number, international standard book number, etc.) or a merchant identifier (e.g., merchant identification number, transaction account number, registration number, point of sale device identifier, etc.). In some embodiments, social network data may be received in response to a request electronically transmitted to the data provider 112 or social network 106 by the processing server 102.

The receiving device 202 may also be configured to receive data signals superimposed with transaction messages from the payment network 116. The transaction messages may be stored in a transaction database 206 of the processing server 102 as transaction messages 208. The transaction database 206 may be configured to store a plurality of transaction messages 208 using a suitable data storage format and schema. Each transaction message may be formatted based on one or more standards, such as the ISO 8583 standard, and may include a plurality of data elements including at least a first data element configured to store a time, a second data element configured to store a date, and one or more additional data elements configured to store transaction data. The transaction data may include, for example, a primary account number, a merchant identification number, a transaction amount, a geographic location, issuer data, acquirer data, merchant data, point of sale data, product data, etc.

The receiving device 202 may also be configured to receive data signals superimposed with an index request, such as from a content provider or other suitable entity, via a suitable communication network. The index request may identify at least an individual 104 for which an index is requested, or a product or merchant for whom a suitable individual 104 is requested, such as one that has shared content associated with the product or merchant or a similar product or merchant. The index request may also include a time and/or date range, a social network 106, or other criteria that may be set forth by the content provider to limit, filter, or otherwise modify the data used in the valuation of the influence of the individual 104.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 214, calculation module 216, and indexing module 218. As used herein, the term “module” may be software or hardware particularly programmed to receive an input, perform one or more processes using the input, and provide an output. The input, output, and processes performed by various modules will be apparent to one skilled in the art based upon the present disclosure.

The querying module 214 of the processing server 102 may be configured to execute queries on databases to identify data stored therein. The querying module 214 may receive a string or one or more data values as input for which data is requested, may execute a query based thereon on a corresponding database, and may output the identified data entries or values. The querying module may, for example, execute a query on the transaction database 206 to identify a group of transaction messages where the transaction time and date stored in the respective data elements included therein are within a predetermined period of time of when content was shared by the individual 104 as based on the received social media data and/or index request, and also where the transaction data stored in the additional data elements corresponds to the product or merchant that was shared.

The calculation module 216 of the processing server 102 may be configured to calculate a rate of return for the individual 104 on the social network 106. The calculation module 216 may receive the group of transaction messages identified by the querying module 214 and the social network data associated with the individual 104 as input, may calculate a rate of return based thereon, and output the calculated rate of return. The rate of return may be based on at least the number of followers 108 and secondary followers 110 for the individual 104 as well as the number of transaction messages in the group of transaction messages. In some embodiments, the rate of return may be the ratio of purchases made to the number of followers 108 and secondary followers 110 to whom the content was shared or potentially shared. In some instances, the rate of return may also be weighted, such as based on the number of followers 108 to secondary followers 110, such as to account for instances where followers 108 may not re-share content to secondary followers 110, where secondary followers 110 may include followers 108, etc. In some instances, such weighting may be based on, for example, the social network 106.

The indexing module 218 of the processing server 102 may be configured to generate an index of influence for the individual 104. The indexing module 218 may receive at least a rate of return for the individual 104, may identify an index for the individual 104 based thereon, and may output the index. In some instances, the index may be based on a comparison of the rate of return for the individual 104 with one or more other rates of return. The other rates of return may include rates of return for the individual 104 for other products or merchants and/or other social networks 106, for other users of the same social network 106, for other users of the same social network 106 and the same or similar product or merchant, etc., and a combination thereof. In some instances, the index may be further based on multiple rates of return for the individual 104, such as by the index taking into account the rate of return for the individual 104 for multiple products and/or merchants and/or multiple social networks 106, which may also take into account rates of return for other users, products, merchants, and/or social networks 106. In some cases, rates of return used to identify an index value may be weighted, such as based on the associated social network 106, product or merchant, number of followers 108, number of secondary followers 110, etc.

In some embodiments, the processing server 102 may include an index database 210. The index database 210 may be configured to store a plurality of index data entries 212 using a suitable data storage format and schema. Each index data entry 212 may be a structured data set configured to store data related to an identified index value, which may include data related to the associated individual 104, such as identifiers for one or more social networks 106 (e.g., usernames, e-mail addresses, etc.), rates of return, contact information, social media data, etc. In some instances, the indexing module 218 may be configured to store an identified index value in an index data entry 212 associated with the individual 104 for which the index value was identified. In such instances, the querying module 214 may be configured to execute a query to add and/or update the index data entry 212 with the index value. In some embodiments, the querying module 214 may be configured to execute a query on the index database 210 to identify an index data entry 212 for an individual for use by the indexing module 218 in identifying an index, such as to retrieve rates of return for the individual 104 for other products, merchants, or social networks 106 as may be stored in the index data entry 212.

The processing server 102 may further include a transmitting device 220. The transmitting device 220 may be configured to transmit data over one or more networks via one or more network protocols. In some embodiments, the transmitting device 220 may be configured to transmit data over the payment rails, such as using specially configured infrastructure associated with payment networks 116 for the transmission of transaction messages that include sensitive financial data and information, such as identified payment credentials. In some instances, the transmitting device 220 may be configured to transmit data to data providers 112, social networks 106, merchants 114, content providers, payment networks 116, and other entities via alternative networks, such as the Internet. In some embodiments, the transmitting device 220 may be comprised of multiple devices, such as different transmitting devices for transmitting data over different networks, such as a first transmitting device for transmitting data over the payment rails and a second transmitting device for transmitting data over the Internet. The transmitting device 220 may electronically transmit data signals that have data superimposed that may be parsed by a receiving computing device. In some instances, the transmitting device 220 may include one or more modules for superimposing, encoding, or otherwise formatting data into data signals suitable for transmission.

The transmitting device 220 may be configured to electronically transmit a data signal to a content provider, such as in response to a received index request. The data signal may be superimposed with an index value identified by the indexing module 218. In some instances, the data signal may also be superimposed with additional value associated thereto, such as contact information for the individual 104 if available, social network data, rate of return data, index values for other users, etc. In some embodiments, the transmitting device 220 may also be configured to electronically transmit data signals to the data provider 112 and/or payment network 116, such as may be superimposed with requests for data, such as social network data and transaction data. In such embodiments, the requests may specify criteria for which data is requested, such as for the individual 104, for a date and/or time range, involving a specific product or merchant, etc.

The processing server 102 may also include a memory 222. The memory 222 may be configured to store data for use by the processing server 102 in performing the functions discussed herein. The memory 222 may be configured to store data using suitable data formatting methods and schema and may be any suitable type of memory, such as read-only memory, random access memory, etc. The memory 222 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art.

### Process for Identifying an Index Using Social Media and Transaction Data

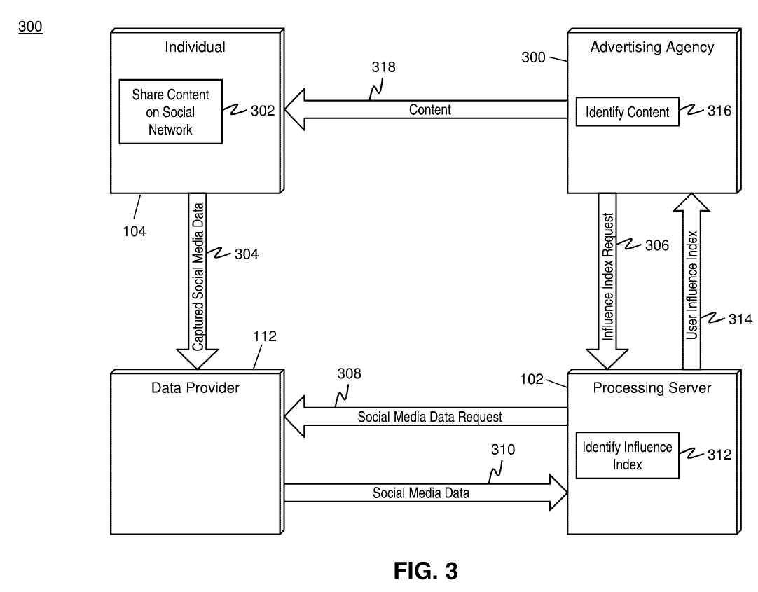

FIG. 3 illustrates a process 300 for the identification of an index value for an individual 104 based on social network data related to the individual 104 and content shared thereby, and transaction data captured for payment transactions involving products or merchants corresponding to the shared content.

In step 302, the individual 104 may share content on a social network 106. The content may include a data value associated with a product or merchant, such as a product or merchant identifier, product or merchant name, product or merchant image, product or merchant audio signal, or other suitable value. The content may be shared at a specific time and date by the individual 104. In step 304, the data provider 112 may capture social media data involving the individual 104, including data associated with the shared content. For example, the data provider 112 may capture a number of followers 108 of the individual 104, as well as a number of secondary followers 110 that corresponds to followers of the followers 108 of the individual 104 on the social network 106. Methods and systems for capturing social media data for an individual 104 from a social network 106 will be apparent to persons having skill in the relevant art.

In step 306, an advertising agency 300 may electronically transmit a data signal to the processing server 102 using a suitable communication network that is superimposed with an influence index request. The influence index request may be received and parsed by the receiving device 202 of the processing server 102, and may include data identifying the individual 104, such as a user identifier and a corresponding social network 106. In some instances, the influence index may also include a product or merchant for which the index is requested. In step 308, the transmitting device 220 of the processing server 102 may electronically transmit a data signal to the data provider 114 using a suitable communication network that is superimposed with a social media data request. The social media data request may include at least the user identifier and corresponding social network 106, and may also include additional data provided by the advertising agency 300 in the influence index request, such as the product or merchant, a time and/or date range, etc.

The data provider 112 may identify the social media data requested by the processing server 102 and may, in step 310, electronically transmit a data signal back to the processing server 102 in response that is superimposed with the requested social media data. The social media data may include the number of followers 108 and secondary followers 110 for the individual 104 as well as sharing data related to content shared by the individual 104 that includes a time and date for sharing of content as well as a data value associated with the shared content (e.g., corresponding to a product or merchant included in the request).

In step 312, the processing server 102 may identify an influence index for the individual 104. As part of step 312, the querying module 214 of the processing server 102 may execute a query on the transaction database 206 to identify transaction messages 208 that were conducted after the sharing of the content, such as where the transaction time and transaction date stored in corresponding data elements included in the transaction message 208 are within a predetermined period of the time and date of the sharing of the content as included in the sharing data, and that involve the product or merchant to which the shared content is associated, such as based on inclusion of the shared data value or data associated therewith in the transaction data in the plurality of additional data elements included in the respective transaction message 208. The calculation module 216 of the processing server 102 may calculate a rate of return for the individual 104 based on the social media data, specifically the number of followers 108 and secondary followers 110, and based on the identified transaction messages 208, specifically the number of identified transaction messages 208. The indexing module 218 may then identify an influence index for the individual 104 based on at least the calculated rate of return.

In step 314, the transmitting device 220 of the processing server 102 may electronically transmit a data signal to the advertising agency 300 using a suitable communication network that is superimposed with at least the identified influence index. In some embodiments, the data signal may also be superimposed with additional data, such as the rate of return, social media data associated with the individual 104, etc. In step 316, the advertising agency 300 may identify content for distribution by the individual 104 that is based on their influence index. In step 318, the advertising agency 300 may electronically transmit a data signal superimposed with the identified content to the individual 104 for sharing.

### Exemplary Method for Generation of an Index of Influence for an Individual Using Social Network and Electronic Transaction Data

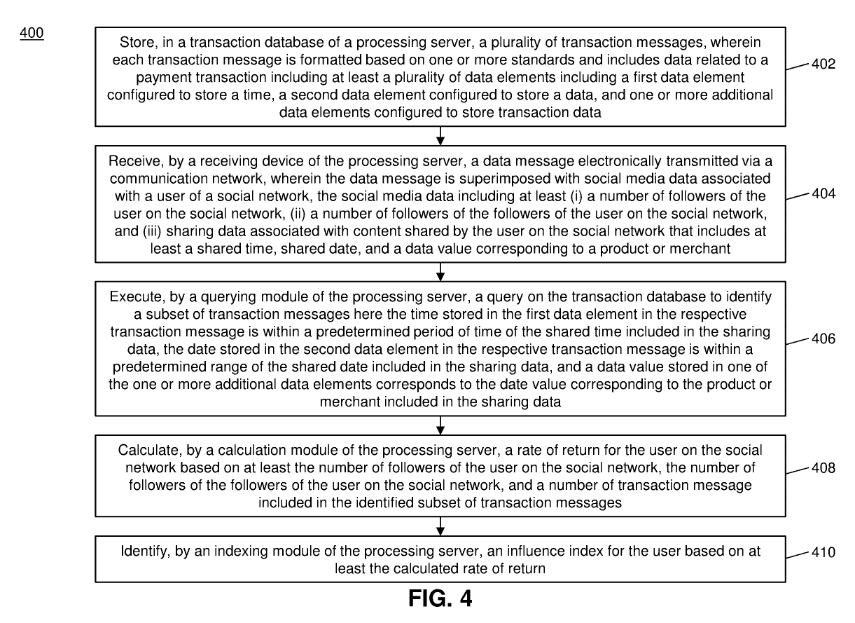

FIG. 4 illustrates a method 400 for the generating of an influence index for an individual on a social network using social media data captured for the social network and electronic transaction data.

In step 402, a plurality of transaction messages (e.g., transaction messages 208) may be stored in a transaction database (e.g., the transaction database 206) of a processing server (e.g., the processing server 102), wherein each transaction message may be formatted based on one or more standards and includes data related to a payment transaction and may include at least a plurality of data elements including a first data element configured to store a time, a second data element configured to store a date, and one or more additional data elements configured to store transaction data. In step 404, a data message electronically transmitted via a communication network may be received by a receiving device (e.g., the receiving device 202) of the processing server, wherein the data message is superimposed with social media data associated with a user (e.g., the individual 104) of a social network (e.g., the social network 106), the social media data including at least (i) a number of followers (e.g., followers 108) of the user on the social network, (ii) a number of followers of the followers of the user (e.g., secondary followers 110) on the social network, and (iii) sharing data associated with content shared by the user on the social network that includes at least a shared time, shared date, and a data value corresponding to a product or merchant (e.g., merchant 114).

In step 406, a query may be executed by a querying module (e.g., the querying module 214) of the processing server on the transaction database to identify a subset of transaction messages where the time stored in the first data element in the respective transaction message is within a predetermined period of time of the shared time included in the sharing data, the date stored in the second data element in the respective transaction message is within a predetermined range of the shared date included in the sharing data, and a data value stored in one of the one or more additional data elements corresponds to the date value corresponding to the product or merchant included in the sharing data. In step 408, a rate of return may be calculated by a calculation module (e.g., the calculation module 216) of the processing server for the user on the social network based on at least the number of followers of the user on the social network, the number of followers of the followers of the user on the social network, and a number of transaction message included in the identified subset of transaction messages.

In step 410, an influence index for the user may be identified by an indexing module (e.g., the indexing module 218) of the processing server based on at least the calculated rate of return. In one embodiment, the method 400 may further include electronically transmitting, by a transmitting device (e.g., the transmitting device 220) of the processing server, a data message to a third party via the communication network, wherein the data message is superimposed with at least the calculated influence index. In a further embodiment, the method 400 may even further include receiving, by the receiving device of the processing server, a data message electronically transmitted via the communication network from the third party, wherein the data message is superimposed with an index request, the index request identifying at least the user and the social network.

In some embodiments, the method 400 may also include electronically transmitting, by the transmitting device of the processing server, a data message via the communication network, wherein the data message is superimposed with a social media data request, the social media data request identifying at least the user and the social network. In a further embodiment, the social media data request may further identify the data value corresponding to the product or merchant. In one embodiment, the influence index may be further based on the social network. In some embodiments, the influence index may be further based on the merchant or product included in the sharing data.

In one embodiment, the method 400 may further include repeating, for a second social network, the receiving, executing, and calculating step to calculate a rate of return for the user on the second social network, wherein the influence index is further based on the calculated rate of return for the user on the second social network. In a further embodiment, the calculated rate of return for the user on the social network and the calculated rate of return for the user on the second social network may be weighted based on the corresponding social network. In another further embodiment, the repeating step may be performed for a second data value corresponding to a different product or merchant

### Payment Transaction Processing System and Process

FIG. 5 illustrates a transaction processing system and a process 500 for the processing of payment transactions in the system. The process 500 and steps included therein may be performed by one or more components of the system 100 discussed above, such as the individual 104, followers 108, secondary followers 110, merchants 114, payment network 116, etc. The processing of payment transactions using the system and process 500 illustrated in FIG. 5 and discussed below may utilize the payment rails, which may be comprised of the computing devices and infrastructure utilized to perform the steps of the process 500 as specially configured and programmed by the entities discussed below, including the transaction processing server 512, which may be associated with one or more payment networks configured to processing payment transactions. It will be apparent to persons having skill in the relevant art that the process 500 may be incorporated into the processes illustrated in FIGS. 3 and 4, discussed above, with respect to the step or steps involved in the processing of a payment transaction. In addition, the entities discussed herein for performing the process 500 may include one or more computing devices or systems configured to perform the functions discussed below. For instance, the merchant 506 may be comprised of one or more point of sale devices, a local communication network, a computing server, and other devices configured to perform the functions discussed below.

In step 520, an issuing financial institution 502 may issue a payment card or other suitable payment instrument to a consumer 504. The issuing financial institution may be a financial institution, such as a bank, or other suitable type of entity that administers and manages payment accounts and/or payment instruments for use with payment accounts that can be used to fund payment transactions. The consumer 504 may have a transaction account with the issuing financial institution 502 for which the issued payment card is associated, such that, when used in a payment transaction, the payment transaction is funded by the associated transaction account. In some embodiments, the payment card may be issued to the consumer 504 physically. In other embodiments, the payment card may be a virtual payment card or otherwise provisioned to the consumer 504 in an electronic format.

In step 522, the consumer 504 may present the issued payment card to a merchant 506 for use in funding a payment transaction. The merchant 506 may be a business, another consumer, or any entity that may engage in a payment transaction with the consumer 504. The payment card may be presented by the consumer 504 via providing the physical card to the merchant 506, electronically transmitting (e.g., via near field communication, wireless transmission, or other suitable electronic transmission type and protocol) payment details for the payment card, or initiating transmission of payment details to the merchant 506 via a third party. The merchant 506 may receive the payment details (e.g., via the electronic transmission, via reading them from a physical payment card, etc.), which may include at least a transaction account number associated with the payment card and/or associated transaction account. In some instances, the payment details may include one or more application cryptograms, which may be used in the processing of the payment transaction.

In step 524, the merchant 506 may enter transaction details into a point of sale computing system. The transaction details may include the payment details provided by the consumer 504 associated with the payment card and additional details associated with the transaction, such as a transaction amount, time and/or date, product data, offer data, loyalty data, reward data, merchant data, consumer data, point of sale data, etc. Transaction details may be entered into the point of sale system of the merchant 506 via one or more input devices, such as an optical bar code scanner configured to scan product bar codes, a keyboard configured to receive product codes input by a user, etc. The merchant point of sale system may be a specifically configured computing device and/or special purpose computing device intended for the purpose of processing electronic financial transactions and communicating with a payment network (e.g., via the payment rails). The merchant point of sale system may be an electronic device upon which a point of sale system application is run, wherein the application causes the electronic device to receive and communicated electronic financial transaction information to a payment network. In some embodiments, the merchant 506 may be an online retailer in an e-commerce transaction. In such embodiments, the transaction details may be entered in a shopping cart or other repository for storing transaction data in an electronic transaction as will be apparent to persons having skill in the relevant art.

In step 526, the merchant 506 may electronically transmit a data signal superimposed with transaction data to a gateway processor 508. The gateway processor 508 may be an entity configured to receive transaction details from a merchant 506 for formatting and transmission to an acquiring financial institution 510. In some instances, a gateway processor 508 may be associated with a plurality of merchants 506 and a plurality of acquiring financial institutions 510. In such instances, the gateway processor 508 may receive transaction details for a plurality of different transactions involving various merchants, which may be forwarded on to appropriate acquiring financial institutions 510. By having relationships with multiple acquiring financial institutions 510 and having the requisite infrastructure to communicate with financial institutions using the payment rails, such as using application programming interfaces associated with the gateway processor 508 or financial institutions used for the submission, receipt, and retrieval of data, a gateway processor 508 may act as an intermediary for a merchant 506 to be able to conduct payment transactions via a single communication channel and format with the gateway processor 508, without having to maintain relationships with multiple acquiring financial institutions 510 and payment processors and the hardware associated thereto. Acquiring financial institutions 510 may be financial institutions, such as banks, or other entities that administers and manages payment accounts and/or payment instruments for use with payment accounts. In some instances, acquiring financial institutions 510 may manage transaction accounts for merchants 506. In some cases, a single financial institution may operate as both an issuing financial institution 502 and an acquiring financial institution 510.

The data signal transmitted from the merchant 506 to the gateway processor 508 may be superimposed with the transaction details for the payment transaction, which may be formatted based on one or more standards. In some embodiments, the standards may be set forth by the gateway processor 508, which may use a unique, proprietary format for the transmission of transaction data to/from the gateway processor 508. In other embodiments, a public standard may be used, such as the International Organization for Standardization's ISO 8583 standard. The standard may indicate the types of data that may be included, the formatting of the data, how the data is to be stored and transmitted, and other criteria for the transmission of the transaction data to the gateway processor 508.

In step 528, the gateway processor 508 may parse the transaction data signal to obtain the transaction data superimposed thereon and may format the transaction data as necessary. The formatting of the transaction data may be performed by the gateway processor 508 based on the proprietary standards of the gateway processor 508 or an acquiring financial institution 510 associated with the payment transaction. The proprietary standards may specify the type of data included in the transaction data and the format for storage and transmission of the data. The acquiring financial institution 510 may be identified by the gateway processor 508 using the transaction data, such as by parsing the transaction data (e.g., deconstructing into data elements) to obtain an account identifier included therein associated with the acquiring financial institution 510. In some instances, the gateway processor 508 may then format the transaction data based on the identified acquiring financial institution 510, such as to comply with standards of formatting specified by the acquiring financial institution 510. In some embodiments, the identified acquiring financial institution 510 may be associated with the merchant 506 involved in the payment transaction, and, in some cases, may manage a transaction account associated with the merchant 506.

In step 530, the gateway processor 508 may electronically transmit a data signal superimposed with the formatted transaction data to the identified acquiring financial institution 510. The acquiring financial institution 510 may receive the data signal and parse the signal to obtain the formatted transaction data superimposed thereon. In step 532, the acquiring financial institution may generate an authorization request for the payment transaction based on the formatted transaction data. The authorization request may be a specially formatted transaction message that is formatted pursuant to one or more standards, such as the ISO 8583 standard and standards set forth by a payment processor used to process the payment transaction, such as a payment network. The authorization request may be a transaction message that includes a message type indicator indicative of an authorization request, which may indicate that the merchant 506 involved in the payment transaction is requesting payment or a promise of payment from the issuing financial institution 502 for the transaction. The authorization request may include a plurality of data elements, each data element being configured to store data as set forth in the associated standards, such as for storing an account number, application cryptogram, transaction amount, issuing financial institution 502 information, etc.

In step 534, the acquiring financial institution 510 may electronically transmit the authorization request to a transaction processing server 512 for processing. The transaction processing server 512 may be comprised of one or more computing devices as part of a payment network configured to process payment transactions. In some embodiments, the authorization request may be transmitted by a transaction processor at the acquiring financial institution 510 or other entity associated with the acquiring financial institution. The transaction processor may be one or more computing devices that include a plurality of communication channels for communication with the transaction processing server 512 for the transmission of transaction messages and other data to and from the transaction processing server 512. In some embodiments, the payment network associated with the transaction processing server 512 may own or operate each transaction processor such that the payment network may maintain control over the communication of transaction messages to and from the transaction processing server 512 for network and informational security.

In step 536, the transaction processing server 512 may perform value-added services for the payment transaction. Value-added services may be services specified by the issuing financial institution 502 that may provide additional value to the issuing financial institution 502 or the consumer 504 in the processing of payment transactions. Value-added services may include, for example, fraud scoring, transaction or account controls, account number mapping, offer redemption, loyalty processing, etc. For instance, when the transaction processing server 512 receives the transaction, a fraud score for the transaction may be calculated based on the data included therein and one or more fraud scoring algorithms and/or engines. In some instances, the transaction processing server 512 may first identify the issuing financial institution 502 associated with the transaction, and then identify any services indicated by the issuing financial institution 502 to be performed. The issuing financial institution 502 may be identified, for example, by data included in a specific data element included in the authorization request, such as an issuer identification number. In another example, the issuing financial institution 502 may be identified by the primary account number stored in the authorization request, such as by using a portion of the primary account number (e.g., a bank identification number) for identification.

In step 538, the transaction processing server 512 may electronically transmit the authorization request to the issuing financial institution 502. In some instances, the authorization request may be modified, or additional data included in or transmitted accompanying the authorization request as a result of the performance of value-added services by the transaction processing server 512. In some embodiments, the authorization request may be transmitted to a transaction processor (e.g., owned or operated by the transaction processing server 512) situated at the issuing financial institution 502 or an entity associated thereof, which may forward the authorization request to the issuing financial institution 502.

In step 540, the issuing financial institution 502 may authorize the transaction account for payment of the payment transaction. The authorization may be based on an available credit amount for the transaction account and the transaction amount for the payment transaction, fraud scores provided by the transaction processing server 512, and other considerations that will be apparent to persons having skill in the relevant art. The issuing financial institution 502 may modify the authorization request to include a response code indicating approval (e.g., or denial if the transaction is to be denied) of the payment transaction. The issuing financial institution 502 may also modify a message type indicator for the transaction message to indicate that the transaction message is changed to be an authorization response. In step 542, the issuing financial institution 502 may transmit (e.g., via a transaction processor) the authorization response to the transaction processing server 512.

In step 544, the transaction processing server 512 may forward the authorization response to the acquiring financial institution 510 (e.g., via a transaction processor). In step 546, the acquiring financial institution may generate a response message indicating approval or denial of the payment transaction as indicated in the response code of the authorization response, and may transmit the response message to the gateway processor 508 using the standards and protocols set forth by the gateway processor 508. In step 548, the gateway processor 508 may forward the response message to the merchant 506 using the appropriate standards and protocols. In step 550, the merchant 506 may then provide the products purchased by the consumer 504 as part of the payment transaction to the consumer 504.

In some embodiments, once the process 500 has completed, payment from the issuing financial institution 502 to the acquiring financial institution 510 may be performed. In some instances, the payment may be made immediately or within one business day. In other instances, the payment may be made after a period of time, and in response to the submission of a clearing request from the acquiring financial institution 510 to the issuing financial institution 502 via the transaction processing server 502. In such instances, clearing requests for multiple payment transactions may be aggregated into a single clearing request, which may be used by the transaction processing server 512 to identify overall payments to be made by whom and to whom for settlement of payment transactions.

In some instances, the system may also be configured to perform the processing of payment transactions in instances where communication paths may be unavailable. For example, if the issuing financial institution is unavailable to perform authorization of the transaction account (e.g., in step 540), the transaction processing server 512 may be configured to perform authorization of transactions on behalf of the issuing financial institution 502. Such actions may be referred to as “stand-in processing,” where the transaction processing server “stands in” as the issuing financial institution 502. In such instances, the transaction processing server 512 may utilize rules set forth by the issuing financial institution 502 to determine approval or denial of the payment transaction, and may modify the transaction message accordingly prior to forwarding to the acquiring financial institution 510 in step 544. The transaction processing server 512 may retain data associated with transactions for which the transaction processing server 512 stands in, and may transmit the retained data to the issuing financial institution 502 once communication is reestablished. The issuing financial institution 502 may then process transaction accounts accordingly to accommodate for the time of lost communication.

In another example, if the transaction processing server 512 is unavailable for submission of the authorization request by the acquiring financial institution 510, then the transaction processor at the acquiring financial institution 510 may be configured to perform the processing of the transaction processing server 512 and the issuing financial institution 502. The transaction processor may include rules and data suitable for use in making a determination of approval or denial of the payment transaction based on the data included therein. For instance, the issuing financial institution 502 and/or transaction processing server 512 may set limits on transaction type, transaction amount, etc. that may be stored in the transaction processor and used to determine approval or denial of a payment transaction based thereon. In such instances, the acquiring financial institution 510 may receive an authorization response for the payment transaction even if the transaction processing server 512 is unavailable, ensuring that transactions are processed and no downtime is experienced even in instances where communication is unavailable. In such cases, the transaction processor may store transaction details for the payment transactions, which may be transmitted to the transaction processing server 512 (e.g., and from there to the associated issuing financial institutions 502) once communication is reestablished.

In some embodiments, transaction processors may be configured to include a plurality of different communication channels, which may utilize multiple communication cards and/or devices, to communicate with the transaction processing server 512 for the sending and receiving of transaction messages. For example, a transaction processor may be comprised of multiple computing devices, each having multiple communication ports that are connected to the transaction processing server 512. In such embodiments, the transaction processor may cycle through the communication channels when transmitting transaction messages to the transaction processing server 512, to alleviate network congestion and ensure faster, smoother communications. Furthermore, in instances where a communication channel may be interrupted or otherwise unavailable, alternative communication channels may thereby be available, to further increase the uptime of the network.

In some embodiments, transaction processors may be configured to communicate directly with other transaction processors. For example, a transaction processor at an acquiring financial institution 510 may identify that an authorization request involves an issuing financial institution 502 (e.g., via the bank identification number included in the transaction message) for which no value-added services are required. The transaction processor at the acquiring financial institution 510 may then transmit the authorization request directly to the transaction processor at the issuing financial institution 502 (e.g., without the authorization request passing through the transaction processing server 512), where the issuing financial institution 502 may process the transaction accordingly.

The methods discussed above for the processing of payment transactions that utilize multiple methods of communication using multiple communication channels, and includes fail safes to provide for the processing of payment transactions at multiple points in the process and at multiple locations in the system, as well as redundancies to ensure that communications arrive at their destination successfully even in instances of interruptions, may provide for a robust system that ensures that payment transactions are always processed successfully with minimal error and interruption. This advanced network and its infrastructure and topology may be commonly referred to as “payment rails,” where transaction data may be submitted to the payment rails from merchants at millions of different points of sale, to be routed through the infrastructure to the appropriate transaction processing servers 512 for processing. The payment rails may be such that a general purpose computing device may be unable to properly format or submit communications to the rails, without specialized programming and/or configuration. Through the specialized purposing of a computing device, the computing device may be configured to submit transaction data to the appropriate entity (e.g., a gateway processor 508, acquiring financial institution 510, etc.) for processing using this advanced network, and to quickly and efficiently receive a response regarding the ability for a consumer 504 to fund the payment transaction.

### Computer System Architecture

FIG. 6 illustrates a computer system 600 in which embodiments of the present disclosure, or portions thereof, may be implemented as computer-readable code. For example, the processing server 102 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-5.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3-5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

The processor device 604 may comprise one or more modules or engines configured to perform the functions of the computer system 600. Each of the modules or engines may be implemented using hardware and, in some instances, may also utilize software, such as corresponding to program code and/or programs stored in the main memory 608 or secondary memory 610. In such instances, program code may be compiled by the processor device 604 (e.g., by a compiling module or engine) prior to execution by the hardware of the computer system 600. For example, the program code may be source code written in a programming language that is translated into a lower level language, such as assembly language or machine code, for execution by the processor device 604 and/or any additional hardware components of the computer system 600. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 600 to perform the functions disclosed herein. It will be apparent to persons having skill in the relevant art that such processes result in the computer system 600 being a specially configured computer system 600 uniquely programmed to perform the functions discussed above.

Techniques consistent with the present disclosure provide, among other features, systems and methods for generation of an index of influence for an individual using social network and electronic transaction data. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for generation of an index of influence for an individual using social network and electronic transaction data, comprising:
storing, in a transaction database of a processing server, a plurality of transaction messages, wherein each transaction message is formatted based on one or more standards and includes data related to a payment transaction including at least a plurality of data elements including a first data element configured to store a time, a second data element configured to store a date, and one or more additional data elements configured to store transaction data;
receiving, by a receiving device of the processing server, a data message electronically transmitted via a communication network, wherein the data message is superimposed with social media data associated with a user of a social network, the social media data including at least (i) a number of followers of the user on the social network, (ii) a number of followers of the followers of the user on the social network, and (iii) sharing data associated with content shared by the user on the social network that includes at least a shared time, shared date, and a data value corresponding to a product or merchant;
executing, by a querying module of the processing server, a query on the transaction database to identify a subset of transaction messages where the time stored in the first data element in the respective transaction message is within a predetermined period of time of the shared time included in the sharing data, the date stored in the second data element in the respective transaction message is within a predetermined range of the shared date included in the sharing data, and a data value stored in one of the one or more additional data elements corresponds to the date value corresponding to the product or merchant included in the sharing data;
calculating, by a calculation module of the processing server, a rate of return for the user on the social network based on at least the number of followers of the user on the social network, the number of followers of the followers of the user on the social network, and a number of transaction messages included in the identified subset of transaction messages; and
identifying, by an indexing module of the processing server, an influence index for the user based on at least the calculated rate of return.

2. The method of claim 1, further comprising:
electronically transmitting, by a transmitting device of the processing server, a data message to a third party via the communication network, wherein the data message is superimposed with at least the calculated influence index.

3. The method of claim 2, further comprising:
receiving, by the receiving device of the processing server, a data message electronically transmitted via the communication network from the third party, wherein the data message is superimposed with an index request, the index request identifying at least the user and the social network.

4. The method of claim 1, further comprising:
electronically transmitting, by a transmitting device of the processing server, a data message via the communication network, wherein the data message is superimposed with a social media data request, the social media data request identifying at least the user and the social network.

5. The method of claim 4, wherein the social media data request further identifies the data value corresponding to the product or merchant.

6. The method of claim 1, wherein the influence index is further based on the social network.

7. The method of claim 1, wherein the influence index is further based on the merchant or product included in the sharing data.

8. The method of claim 1, further comprising:
repeating, for a second social network, the receiving, executing, and calculating step to calculate a rate of return for the user on the second social network, wherein
the influence index is further based on the calculated rate of return for the user on the second social network.

9. The method of claim 8, wherein the calculated rate of return for the user on the social network and the calculated rate of return for the user on the second social network are weighted based on the corresponding social network.

10. The method of claim 8, wherein the repeating step is performed for a second data value corresponding to a different product or merchant.

11. A system for generation of an index of influence for an individual using social network and electronic transaction data, comprising:
a transaction database of a processing server configured to store a plurality of transaction messages, wherein each transaction message is formatted based on one or more standards and includes data related to a payment transaction including at least a plurality of data elements including a first data element configured to store a time, a second data element configured to store a date, and one or more additional data elements configured to store transaction data;
a receiving device of the processing server configured to receive a data message electronically transmitted via a communication network, wherein the data message is superimposed with social media data associated with a user of a social network, the social media data including at least (i) a number of followers of the user on the social network, (ii) a number of followers of the followers of the user on the social network, and (iii) sharing data associated with content shared by the user on the social network that includes at least a shared time, shared date, and a data value corresponding to a product or merchant;
a querying module of the processing server configured to execute a query on the transaction database to identify a subset of transaction messages where the time stored in the first data element in the respective transaction message is within a predetermined period of time of the shared time included in the sharing data, the date stored in the second data element in the respective transaction message is within a predetermined range of the shared date included in the sharing data, and a data value stored in one of the one or more additional data elements corresponds to the date value corresponding to the product or merchant included in the sharing data;
a calculation module of the processing server configured to calculate a rate of return for the user on the social network based on at least the number of followers of the user on the social network, the number of followers of the followers of the user on the social network, and a number of transaction messages included in the identified subset of transaction messages; and
an indexing module of the processing server configured to identify an influence index for the user based on at least the calculated rate of return.

12. The system of claim 11, further comprising:
a transmitting device of the processing server configured to electronically transmit a data message to a third party via the communication network, wherein the data message is superimposed with at least the calculated influence index.

13. The system of claim 12, wherein the receiving device of the processing server is further configured to receive a data message electronically transmitted via the communication network from the third party, wherein the data message is superimposed with an index request, the index request identifying at least the user and the social network.

14. The system of claim 11, further comprising:
a transmitting device of the processing server configured to electronically transmit a data message via the communication network, wherein the data message is superimposed with a social media data request, the social media data request identifying at least the user and the social network.

15. The system of claim 14, wherein the social media data request further identifies the data value corresponding to the product or merchant.

16. The system of claim 11, wherein the influence index is further based on the social network.

17. The system of claim 11, wherein the influence index is further based on the merchant or product included in the sharing data.

18. The system of claim 11, further comprising:
repeating, for a second social network, the receiving, executing, and first calculating step to calculate a rate of return for the user on the second social network, wherein
the influence index is further based on the calculated rate of return for the user on the second social network.

19. The system of claim 18, wherein the calculated rate of return for the user on the social network and the calculated rate of return for the user on the second social network are weighted based on the corresponding social network.

20. The system of claim 18, wherein the repeating step is performed for a second data value corresponding to a different product or merchant.
